(19) United States
(12) Patent Application Publication
(10) Pub. No.: US 2026/0348348 A1
(43) Pub. Date: Nov. 5, 2026

(54) FUEL INJECTOR HAVING TAPPET EQUIPPED WITH SEALING ELEMENT AND METHODOLOGY

(71) Applicant: Caterpillar Inc., Peoria, IL (US)

(72) Inventors: Steven D. Wehri, Pontiac, IL (US); Eric L. Rogers, El Paso, IL (US); Christopher R. Jones, Washington, IL (US)

(73) Assignee: Caterpillar Inc., Peoria, IL (US)

(21) Appl. No.: 19/196,129

(22) Filed: May 1, 2025

(51) Int. Cl. F02M 63/00

(52) U.S. Cl. CPC F02M 63/0014

(57) ABSTRACT

A fuel injector includes an injector housing having a nozzle with a plurality of spray orifices formed therein, an injection valve movable to open and close the plurality of spray orifices, a fuel plunger movable in a plunger cavity, and a tappet. The tappet is movable in response to rotation of a cam and includes a first, actuated end, and a second, driving end in contact with the fuel plunger. The fuel injector also includes a clearance defined between the tappet and the injector housing, and a sealing element held in compression between the tappet and the injector housing and fluidly sealing the clearance. Related methodology is also disclosed.

### TECHNICAL FIELD

The present disclosure relates generally to a fuel injector, and more particularly to a tappet in a fuel injector or pumping assembly therefor equipped with a sealing element to limit fuel leakage.

### BACKGROUND

Many modern internal combustion engines are fuel-injected, commonly direct-injected in compression-ignition engines. In a typical arrangement, a fuel injector is provided that extends partially into a combustion cylinder in an engine. The fuel injector is supplied with pressurized fuel, or pressurizes fuel therein, and injects the same at an injection pressure into the cylinder at a desired injection timing. The fuel is combusted with air to increase temperature and pressure in the cylinder and thereby drive a piston coupled to a crankshaft. Engines of this general type are used in a wide variety of applications ranging from powering vehicle powertrains to electric power generation.

Fuel injectors commonly include numerous small and rapidly moving parts, subjected to high fluid pressures, impacts, and otherwise generally harsh and repetitive operation over at least millions of operating cycles. Components of the fuel injector must be capable of withstanding fluid pressures commonly in the hundreds of mega-Pascals (MPa) for many applications. As a result, clearances between parts of the fuel injector can be prone to leakage, and fuel injectors are often designed to permit a certain degree of leakage. One example mechanically actuated fuel injector is known from United States Patent Application Publication No. 2003/0057293 A1 to Boecking.

### SUMMARY

In one aspect, a fuel injector includes an injector housing having a nozzle with a plurality of spray orifices formed therein, an injection valve movable to open and close the plurality of spray orifices, a fuel plunger movable in a plunger cavity, and a tappet. The tappet is movable in response to rotation of a cam and includes a first, actuated end, and a second, driving end in contact with the fuel plunger. The fuel injector also includes a clearance defined between the tappet and the injector housing, and a sealing element held in compression between the tappet and the injector housing and fluidly sealing the clearance.

In another aspect, a fuel injector pumping assembly includes a housing, and a tappet defining a longitudinal axis and having a first, cam-actuated end and a second, plunger-driving end, an enlarged head located at the first, cam-actuated end, and a return spring concentrically positioned around the tappet. A tappet clearance is defined between the tappet and the injector housing. The fuel injector pumping assembly also includes a sealing element held in radial compression between the first, cam-actuated end and the second, plunger-driving end of the tappet and the housing, and fluidly sealing the tappet clearance in axial sliding contact with at least one of the tappet or the housing.

In yet another aspect, operating a fuel injector includes advancing a tappet in a fuel injector toward an advanced position in response to rotation of a cam. Operating the fuel injector also includes pressurizing a fuel to an injection pressure in a plunger cavity in the fuel injector based on the advancing of the tappet. Operating the fuel injector further includes biasing a sealing element in contact with the tappet outwardly into sealing contact with an injector housing during the advancing of the tappet, and limiting migration of pressurized fuel from the plunger cavity through a leakage path defined by a tappet clearance fluidly connected to a plunger clearance, based on the sealing contact.

### BRIEF DESCRIPTION OF DRAWINGS

FIG. 1 is a diagrammatic view of an internal combustion engine system, according to one embodiment;

FIG. 2 is a sectioned side diagrammatic view of a fuel injector, according to one embodiment;

FIG. 3 is a sectioned diagrammatic view of a tappet, including a detailed enlargement, according to one embodiment;

FIG. 4 is a partially sectioned diagrammatic view of a sealing element positioned for service in a fuel injector, according to one embodiment; and

FIG. 5 is a partially sectioned view of a sealing element, according to one embodiment.

### DETAILED DESCRIPTION

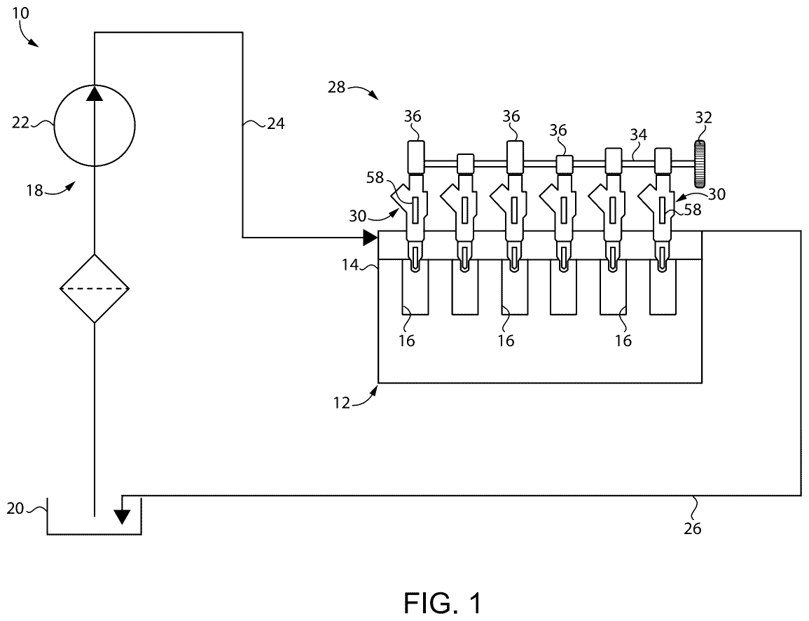

Referring to FIG. 1, there is shown an internal combustion engine system 10, according to one embodiment. Engine system 10 may be used in any known application, such as operating a driveline in a land vehicle or a marine vessel, operating a pump, a compressor, or an electrical generator to name a few examples. Engine system 10 includes an internal combustion engine 12, having an engine housing 14 with a plurality of cylinders 16 formed therein. Engine system 10 can include any number of cylinders in any suitable configuration, such as inline, a V-pattern, or still another. It will be appreciated that a plurality of pistons will be positioned in cylinders 16 and typically each movable between a top-dead-center position and a bottom-dead-center position in a generally conventional manner, typically in a four-stroke engine cycle. Engine system 10 will typically be operated as a compression-ignition engine wherein pistons in cylinders 16 increase cylinder pressure and temperature to an auto-ignition threshold. However, the present disclosure is not limited to any particular ignition strategy.

Engine system 10 also includes a fuel system 18. Fuel system 18 may include at least one supply of a liquid fuel 20. Fuel supply 20 could include a compression-ignition fuel, such as a diesel distillate fuel, a lower cetane fuel blended with a cetane enhancer, or a variety of so-called alternative fuels such as bio-diesel, distillate diesel blended with bio-diesel or otherwise having some degree of bio-content, renewable fuels such as various seed oils, alcohol fuels such as methanol, ethanol, or various blends, for example. Fuel system 18 may be designed to selectively provide multiple fuels, including variable blend ratios in some embodiments.

Fuel system 18 also includes at least one fuel pump 22 arranged to feed a liquid fuel from fuel supply 20 to engine housing 14 by way of a fuel supply conduit 24. A fuel return conduit 26 conveys fuel from engine housing 14 that is not injected for combustion back to fuel supply 20. Fuel system 18 may also include one or more fuel injector pumping assemblies 28 and a plurality of direct fuel injectors 30. A fuel injector pumping assembly according to the present disclosure may be part of and thus resident on a fuel injector, or separate from and still fluidly connected to a fuel injector. One pumping assembly 28 could be arranged to pressurize fuel for more than one fuel injector in fuel system 18 in some embodiments. In some arrangements, fuel is conveyed through engine housing 14 to the plurality of direct fuel injectors 30. In other arrangements, fuel injectors 30 could be supplied with fuel in a so-called top feed arrangement such that fuel supply does not pass directly through engine housing 14. Arrangements where fuel injectors 30 include port injectors are also within the scope of the present disclosure.

Fuel injectors 30 may be mechanically actuated to pressurize the fuel to an injection pressure. To this end, engine system 10 further includes a cam gear 32 typically operated by way of an engine geartrain (not shown) and coupled to a camshaft 34. Camshaft 34 includes a plurality of cam lobes 36 that rotate in contact with fuel injectors 30 to actuate respective tappets 58 as further discussed herein.

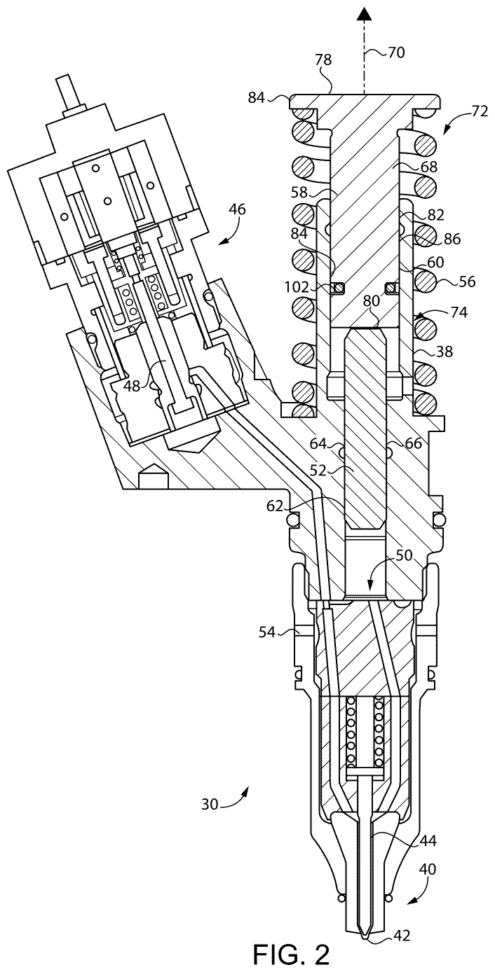

Referring also now to FIG. 2, there are shown features of an example one of fuel injectors 30, hereinafter referred to, at times, in the singular. Description and discussion herein of a fuel injector can be understood to refer by way of analogy to a fuel injector pumping assembly except where otherwise indicated or apparent from the context. Fuel injector 30 includes an injector housing 38 having a nozzle 40. Nozzle 40 extends into a corresponding cylinder 16 when fuel injector 30 is installed for service and includes a plurality of spray orifices 42 formed therein. Fuel injector 30 further includes an injection valve 44, such as a needle valve, movable to open and close spray orifices 42 in a generally conventional manner.

Fuel injector 30 may further include a spill valve assembly 46 having a spill valve 48. Spill valve 48 may be operated by way of an electrical actuator assembly (not numbered) in some embodiments. In FIG. 2, spill valve 48 is shown partly within fuel injector 30, but it should be understood that placement of spill valve 48 may vary depending on engine and/or fuel system design, for instance, spill valve 48 may be external to fuel injector 30 and fluidly connected, arranged as a “side car” approximately as shown, or integrated into the main portion of fuel injector 30 at least substantially coaxially with injection valve 44.

Spill valve assembly 46 may also be operable in a generally known manner to selectively fluidly connect a plunger cavity 50 formed in injector housing 38 to a low-pressure fuel supply or other low pressure space defined by fuel injector 30, such as fuel supply conduit 24, and such that when spill valve 48 is closed advancing of a fuel plunger 52 increases a pressure of fuel in plunger cavity 50 to an injection pressure. Put differently, spill valve 48 may be movable to vary a fluid connection between plunger cavity 50 and a low-pressure space to permit plunger 52 to pressurize fuel when spill valve 48 is closed, and to passively draw fuel into and expel fuel from plunger cavity 50 when spill valve 48 is open.

Injector housing 38 also forms a low-pressure fuel inlet 54 that may be connected to fuel supply conduit 24. In some embodiments, reaching injection pressure may cause opening hydraulic pressure on injection valve 44 to overcome an opposing force of a return spring 56 on injection valve 44. When pressure decreases below an injection pressure, injection valve 44 is closed by the force of a return spring. Put differently, injection timing may be controlled by a fuel pressure within fuel injector 30, with the fuel pressure in turn varied by opening and closing spill valve 48. In other embodiments, injection valve 44 could be directly controlled by way of an electrohydraulic control valve assembly that varies a closing hydraulic pressure on a closing hydraulic surface of injection valve 44 according to generally known principles.

Fuel injector 30 may include a tappet 58 as noted above. Injector housing 38 may form a tappet bore 60, within which tappet 58 may be reciprocally disposed. Tappet 58 may interface with fuel plunger 52, which may be axially aligned within a separate but coaxially arranged plunger bore 62. Tappet 58 and fuel plunger 52 may be in direct or indirect mechanical engagement, such that axial movement of tappet 58 induces corresponding movement of fuel plunger 52. “Axial movement” means movement along and in a direction of an axis, thus axial movement of tappet 58 and/or fuel plunger 52 means movement up and down in the illustrated embodiment. A plunger clearance 64 may be defined between fuel plunger 52 and an inner plunger bore surface 66. Plunger clearance 64 may be fluidly connected to plunger cavity 50.

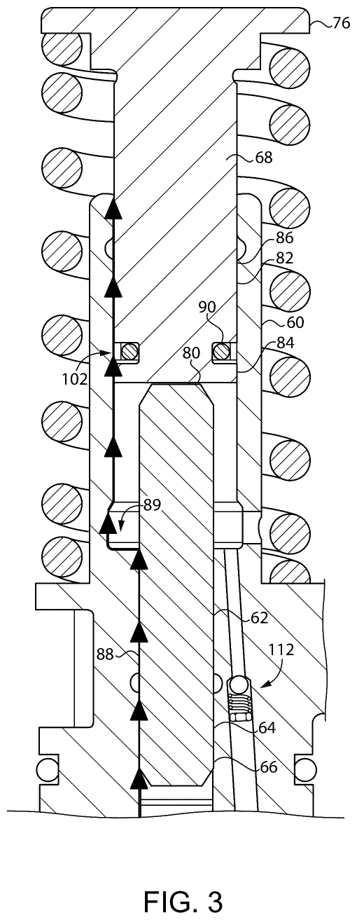

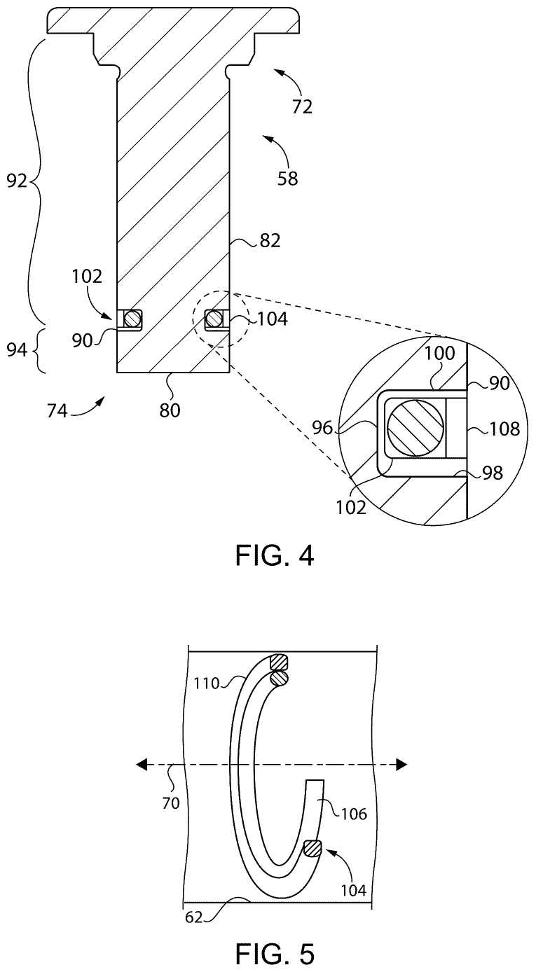

Referring also now to FIGS. 3 and 4 there are shown additional features of tappet 58 in further detail. Tappet 58 may include a generally cylindrical tappet body 68 defining a longitudinal axis 70 extending from a first, actuated end 72 to a second, driving end 74. Tappet body 68 may be formed of a metallic material, such as a metallic alloy. First, actuated end 72 may include an enlarged head 76 formed or affixed thereto. Enlarged head 76 may be structured to maintain continuous contact with cam lobe 36. Enlarged head 76 may include a cam-contacting surface 78 machined to a flat or convex profile, for example, and extending orthogonally to longitudinal axis 70. Enlarged head 76 may have a greater outer diameter relative to tappet body 68 to optimize a cam-contact surface area, for instance. Return spring 56 may be concentrically positioned around tappet body 68, and may be utilized to act directly upon tappet 58, thereby providing an upward biasing force to restore tappet 58 to a retracted position following advancement.

Second, driving end 74 may include a plunger-contacting surface 80. Plunger-contacting surface 80 may be flat to transmit forces to fuel plunger 52. Tappet body 68 may also include an outer tappet surface 82 extending around longitudinal axis 70, and a tappet clearance 84 may be defined between outer tappet surface 82 and an inner tappet bore surface 86. Put differently, tappet clearance 84 is defined between tappet 58 and injector housing 38. Tappet clearance 84 may be fluidly connected to plunger cavity 50. The fluid connections between tappet clearance 84, plunger clearance 64, and plunger cavity 50, together form a leakage path 88.

Leakage path 88 may advance from plunger clearance 64 to tappet clearance 84 by way of a space or inter-clearance cavity 89 defined around fuel plunger 52. As will be further apparent from the forthcoming discussion, a seal may be utilized to impede tappet clearance 84. A seal groove 90 may be formed axially between first, actuated end 72 and a second, driving end 74 of tappet body 68 and extends circumferentially around longitudinal axis 70. A first distance 92 may be defined between first, actuated end 72 and seal groove 90, and a second distance 94 may be defined between second, driving end 74 and seal groove 90. As shown, first distance 92 may be greater than second distance 94, and seal groove positioned closer to second, driving end 74 than to first, actuated end 72. Seal groove 90 may form a three-sided profile including a radially inward surface 96, an axially inward surface 98, and an axially outward surface 100. A sealing element 102 may be held in compression between tappet 58 and injector housing 38 and fluidly seals tappet clearance 84 via axial sliding contact with injector housing 38. Sealing element 102 may be carried on tappet 58 during operation of engine system 10. In other embodiments, a sealing element might be positioned in an injector housing and remain fixed relative to a tappet, such that the sealing element does not move with the tappet during operation. Still other embodiments of a sealing element could include more than one seal, one fixed and one carried on a tappet, for example. Thus, a sealing element in accordance with the present disclosure may be biased into sealing contact with at least one of injector housing 38 or tappet body 68.

FIG. 5 shows a detailed enlargement including additional features of sealing element 102. It should be understood that sealing element 102 as shown in FIG. 5, is depicted in a compressed state, which may correspond to a configuration sealing element 102 could assume when installed for service. In a practical implementation, sealing element 102 may include a compound sealing element 104 having multiple parts. Compound sealing element 104 may include an inner seal energizer 106 and an outer face seal 108. Inner seal energizer 106 may be fabricated from a first material such as an elastic natural or synthetic rubber material, or still other materials compatible with hydrocarbon-based fuels. Inner seal energizer 106 may be, for example, an O-ring, and may be structured to seat within seal groove 90 and provide a compressible backing to outer face seal 108. When positioned upon tappet 58, inner seal energizer 106 may be held in radial compression between outer face seal 108 and tappet 58.

Outer face seal 108 may be fabricated from a second, different material than the first material. The second material could be, for example, a non-rubber material, such as an elastomeric material or a polytetrafluoroethylene (PTFE) material, or still something else. Outer seal face 108 may be molded with, or otherwise mechanically coupled to, inner seal energizer 106 and maintained in radial compression under variable thermal conditions and variable fuel pressures. Outer face seal 108 could be bonded to inner seal energizer 106 using an adhesive or coupling agent. As illustrated, compound sealing element 104 may include an annular outer sealing surface 110 structured to engage in axial sliding and sealing contact at an adjacent sealing location, such as inner tappet bore surface 86. The sealing interface of outer sealing surface 110 may block leakage path 88 thereby inhibiting fluid migration through tappet clearance 84 in a generally axial direction.

As also shown, fuel injector 30 may also include a drain conduit or passage 112 formed in injector housing 38. Drain passage 112 fluidly connects to leakage path 88 at a location fluidly between plunger clearance 64 and tappet clearance 84, and may be opened and closed via a check valve (not numbered) biased toward a closed position blocking leakage of fuel from leakage path 88. Drain passage 112 may fluidly connect to fuel supply conduit 14. When tappet 58 moves downward the motion of tappet 58 can urge leaked fuel out through drain passage 112.

### Industrial Applicability

In fuel injection systems, it is common for a portion of fuel to escape from the fuel injector during operation and potentially make its way into the engine's oil system. This is particularly common due to the high pressures involved in fuel delivery in some systems. Diesel fuel, when mixed within engine oil, typically vaporizes relatively readily during operation, thereby mitigating any contamination that might occur. Thus, in at least some fuel systems the leakage of a relatively small amount of fuel is tolerated, and could even be desirable where leaked diesel can assist in lubrication and/or cooling of various parts.

Fuel leakage may be less tolerable in other instances, including in industries and certain jurisdictions transitioning to biodiesel fuels or other alternatives. Such fuels other than diesel distillates tend to have a lower volatility and do not evaporate as easily, thereby increasing the potential of persistent contamination of an oil system. The present disclosure therefore addresses potential concerns by providing solutions to limit or eliminate migration of fuel into the oil system under such operating conditions.

Operating fuel injector 30 can include advancing tappet 58 in fuel injector 30 toward an advanced position in response to rotation of a corresponding cam lobe 36. When fuel is pressurized to an injection pressure in plunger cavity 50 in fuel injector 30 based on the advancing of fuel plunger 52, some fuel leakage through leakage path 88 may occur. Sealing element 102 is maintained in sealing contact with injector housing 38 during advancing and retracting of tappet 58, thereby impeding tappet clearance 84. Thus, any leaked fuel can tend to find its way to drain passage 112, potentially being urged out as tappet 58 moves downward.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel injector comprising:
an injector housing including a nozzle having a plurality of spray orifices formed therein, an injection valve movable to open and close the plurality of spray orifices, a fuel plunger movable in a plunger cavity, and a tappet;
the tappet movable in response to rotation of a cam and including a first, actuated end, and a second, driving end in contact with the fuel plunger;
a clearance is defined between the tappet and the injector housing; and
a sealing element held in compression between the tappet and the injector housing and fluidly sealing the clearance.

2. The fuel injector of claim 1 wherein the sealing element includes a compound sealing element.

3. The fuel injector of claim 2 wherein the compound sealing element is carried on the tappet.

4. The fuel injector of claim 3 wherein the compound sealing element includes an inner seal energizer, and an outer face seal, and the inner seal energizer is held in compression between the outer face seal and the tappet.

5. The fuel injector of claim 4 wherein the outer face seal is formed of a first material, and the inner seal energizer is formed of a second material different from the first material.

6. The fuel injector of claim 4 further including a seal groove formed in the tappet, and the inner seal energizer includes an O-ring seated in the seal groove.

7. The fuel injector of claim 6 wherein a first distance is defined between the first, actuated end and the seal groove, and a second distance is defined between the second, driving end and the seal groove, and the first distance is greater than the second distance.

8. The fuel injector of claim 1 further comprising a spill valve movable to vary a fluid connection between the plunger cavity and a low-pressure space defined by the fuel injector.

9. A fuel injector pumping assembly comprising:
a housing;
a tappet defining a longitudinal axis and including a first, cam-actuated end and a second, plunger-driving end, an enlarged head located at the first, cam-actuated end, and a return spring concentrically positioned around the tappet;
a tappet clearance is defined between the tappet and the housing; and
a sealing element held in radial compression between the first, cam-actuated end and the second, plunger-driving end of the tappet and the housing, and fluidly sealing the tappet clearance in axial sliding contact with at least one of the housing or the tappet.

10. The fuel injector pumping assembly of claim 9 wherein the sealing element includes a compound sealing element.

11. The fuel injector pumping assembly of claim 10 wherein the compound sealing element includes an inner seal energizer in contact with the tappet, and an outer face seal, and the inner seal energizer is held in compression between the outer face seal and the tappet.

12. The fuel injector pumping assembly of claim 11 wherein the inner seal energizer is formed of an elastic material, and the outer face seal is formed of a second, different material.

13. The fuel injector pumping assembly of claim 11 further including a seal groove formed in the tappet, and the inner seal energizer is seated in the seal groove.

14. The fuel injector pumping assembly of claim 13 wherein the seal groove is positioned closer to the second, plunger-driving end than to the first, cam-actuated end.

15. The fuel injector pumping assembly of claim 9 further including a fuel plunger defining a plunger clearance between the fuel plunger and the housing.

16. The fuel injector pumping assembly of claim 15 further including a leakage path advancing from the plunger clearance through the tappet clearance, and a drain passage formed in the housing fluidly connects to the leakage path at a location fluidly between the plunger clearance and the tappet clearance.

17. The fuel injector pumping assembly of claim 16 wherein the housing further forms a tappet bore coaxially arranged with a plunger bore, and wherein the tappet and the fuel plunger are both resident in the housing within the tappet bore and the plunger bore, respectively, and the fuel injector pumping assembly is integrated in a fuel injector.

18. A method of operating a fuel injector comprising:
advancing a tappet in a fuel injector toward an advanced position in response to rotation of a cam;
pressurizing a fuel to an injection pressure in a plunger cavity in the fuel injector with a plunger operated via the advancing of the tappet;
biasing a sealing element in contact with the tappet outwardly into sealing contact with an injector housing during the advancing of the tappet; and
limiting migration of pressurized fuel from the plunger cavity through a leakage path defined by a tappet clearance fluidly connected to a plunger clearance, based on the sealing contact.

19. The method of claim 18 wherein the sealing element includes a compound sealing element having an inner seal energizer and an outer face seal.

20. The method of claim 18 further comprising draining fuel leaked through the plunger clearance via a drain passage fluidly connected to the leakage path at a location fluidly between the plunger clearance and the tappet clearance.
